(19) United States
(12) Patent Application Publication
(10) Pub. No.: US 2014/0221537 A1
(43) Pub. Date: Aug. 7, 2014

(54) FLAME RETARDANT POLYAMIDE RESIN COMPOSITIONS

(71) Applicants: Lotte Chemical Corporation, Seoul (KR); Hyundai Motor Company, Seoul (KR)

(72) Inventors: Jee-Young Youn, Incheon (KR); Sung-Rok Ko, Daejeon (KR); Sung-Min Cho, Daejun (KR); Young-Min Cho, Daejeon (KR)

(73) Assignees: LOTTE CHEMICAL CORPORATION, Seoul (KR); HYUNDAI MOTOR COMPANY, Seoul (KR)

(21) Appl. No.: 13/954,106

(22) Filed: Jul. 30, 2013

(30) Foreign Application Priority Data
Feb. 5, 2013 (KR) 10-2013-0013048

(51) Int. Cl. C08K 3/34; C08K 3/00

(52) U.S. Cl. CPC C08K 3/346; C08K 3/0033
USPC 524/100; 524/606; 524/414; 524/415; 524/141; 524/451; 524/425; 524/447; 524/456; 524/445

(57) ABSTRACT

Disclosed is a flame retardant polyamide resin composition, and more particularly, a flame retardant polyamide resin composition having improved flame retardancy and further having improved strength, heat resistance, moisture absorption resistance, dimensional stability, and the like by including a polyamide nanocomposite in which an organized layered clay compound is contained by in-situ polymerization, a filler, and a phosphorus-based flame retardant. The composition has high economic efficiency because the composition is lighter and has a lower production cost than flame retardant materials in the related art.

### CROSS-REFERENCE TO RELATED APPLICATIONS

This application claims priority under 35 U.S.C. §119 to Korean Patent Application No. 10-2013-0013048, filed on Feb. 5, 2013, in the Korean Intellectual

Property Office, the disclosure of which is incorporated herein by reference in its entirety.

### BACKGROUND OF THE INVENTION

1. Field of the Invention

The present invention relates to a flame retardant polyamide resin composition, particularly, a polyamide resin composition with improves flame retardancy, and also improved strength, heat resistance, moisture absorption resistance, lightweight property, dimensional stability, and the like. More particularly, such properties may be provided by including a polyamide nanocomposite that contains an organized layered clay compound, a filler, and a phosphorus-based flame retardant.

2. Description of the Related Art

In recently developed electric vehicles and hybrid vehicles, the number of electric and electronic parts is increasing. In response to the above, the application of a high-capacity battery has increased. At the same time, the need for a flame retardant plastic material that can prevent fire is increasing. Further, when ignition occurs due to collision between vehicles and the like, the application of a flame retardant material which can minimize transmission of fire is essential to ensure passenger safety.

There are various methods of making a flame retardant plastic material. One method involves making a plastic having improved flame retardancy by adding a flame retardant to the plastic material. However, adding the flame retardant to the plastic material may cause problems, such as an increase in production costs, an increase in the weight of the plastic, and a resulting hazardous property of the flame retardant material itself.

In general, a polyamide resin is an engineering plastic having excellent heat resistance and mechanical properties. Polyamide resins have been widely used in various machines, electric and electronic parts, and parts of vehicles. Further, the strength, heat resistance, dimensional stability, and the like of the polyamide resin may be improved by adding an inorganic-based fiber, an inorganic powder, and the like thereto. As such, the polyamide resin is industrially and widely used.

However, polyamide resin is disadvantageous because it has a high moisture absorptivity. Once moisture is absorbed, problems in the polyamide resin occur, such as a decrease in strength, reduction in dimensional stability, deterioration in molding proccessability, reduction in flame retardancy, and the like. Due to the aforementioned problems, polyamide resin is incapable of sufficiently satisfying all the desired characteristics, such as rigidity, dimensional stability, heat resistance, flame retardancy, and the like, which are required for various machines, electric and electronic parts, and parts of vehicles.

Accordingly, studies to overcome the aforementioned problems have been continuously conducted. Korean Patent No. 10-0945911 suggests a polyamide nanocomposite and a manufacturing method thereof. The polyamide nanocomposite includes clay, and thus has improved heat resistance. However, it is disadvantageous in that the polyamide nanocomposite has no flame retardancy and has a high specific weight.

Korean Patent Application Laid-Open No. 2002-0029380 suggests a preparation method of a polyamide nanocomposite composition by in-situ polymerization. However, while the physical properties of polyamide are increased by polymerizing polyamide and a silicate material, there is no mention of flame retardancy.

### SUMMARY OF THE INVENTION

The present invention provides a flame retardant polyamide resin composition having improved flame retardancy, strength, heat resistance, moisture absorption resistance, lightweight property, and dimensional stability while decreasing costs thereof as compared to flame retardant materials in the related art. In particular, the present composition applies a polyamide nanocomposite in which an organized layered clay compound is contained by in-situ polymerization.

According to one aspect, the present invention provides a flame retardant polyamide resin composition including a polyamide nanocomposite in which an organized layered clay compound is contained; a filler; and a phosphorus-based flame retardant.

According to various embodiments, the flame retardant polyamide resin composition includes about 0.1 to 10% by weight of the organized layered clay compound, about 40 to 98% by weight of the polyamide nanocomposite, about 1 to 45% by weight of the filler, and about 1 to 30% by weight of the phosphorus-based flame retardant, based on the total weight of the flame retardant polyamide resin composition.

According to various embodiments, the polyamide nanocomposite includes one or more selected from the group consisting of polyamide 6, polyamide 66, polyamide 11, polyamide 12, polyamide 610, polyamide 612, polyamide 4, and a polyamide copolymer.

The organized layered clay compound may be introduced into the polyamide nanocomposite by known methods, such as in-situ polymerization. According to an exemplary embodiment, the polyamide nanocomposite may have a relative viscosity of about 2.5 to 3.5.

According to various embodiments, the filler is a fibrous reinforcing material or inorganic filler.

For example, the fibrous reinforcing material may include one or more selected from the group consisting of glass fiber, carbon fiber, natural fiber, mineral fiber, and metal fiber, and the inorganic filler may include one or more selected from the group consisting of talc, whisker, calcium carbonate, silica, kaolin, wallstonate, and a layered clay compound.

According to various embodiments, the phosphorus-based flame retardant includes one or more selected from the group consisting of white phosphorus, red phosphorus, ammonium polyphosphate (APP), triphenyl phosphate (TPP), and melanine.

The present invention having the aforementioned configuration provides a composition having improved flame retardancy by including a polyamide nanocomposite in which a layered clay compound is included, a filler, and a phosphorus-based flame retardant.

The composition of the present invention further provides improved strength, heat resistance, moisture absorption resistance, lightweight property, dimensional stability, and the like.

Furthermore, when the flame retardant polyamide resin composition according to the present invention is compared with a flame retardant material in the related art, there is an advantage in that the present composition is lighter in weight and production costs are reduced, while physical properties and flame retardancy are improved. Thus, there is an advantage in that the present composition reduces the weight and costs when applied to vehicles, electric and electronic parts, home appliances, engineering plastics, and the like.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a cross-sectional view of the polyamide nanocomposite in which the organized layered clay compound is contained according to an embodiment of the present invention. It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Terms or words used in the present specification and claims should not be interpreted as being limited to typical or dictionary meanings, but should be interpreted as having meanings and concepts, which comply with the technical spirit of the present invention, based on the principle that an inventor can appropriately define the concept of the term to describe his/her own invention in the best manner.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present invention will be described in detail with reference to Tables and drawings.

The present invention relates to a flame retardant polyamide resin composition.

The flame retardant polyamide resin composition according to the present invention is characterized in that it includes a polyamide nanocomposite in which an organized layered clay compound is contained, a filler, and a phosphorus-based flame retardant. Each constituent component will be explained below in further detail.

### (1) Polyamide Nanocomposite

A polyamide nanocomposite is a basic material of the present invention having properties, such as flame retardancy, moisture stability, heat resistance, lightweight property, and the like. It is preferred that the polyamide nanocomposite includes one or more selected from the group consisting of polyamide 6, polyamide 66, polyamide 11, polyamide 12, polyamide 610, polyamide 612, polyamide 4, a polyamide copolymer, and the like.

Further, it is preferred that the polyamide nanocomposite is formed by introducing a layered clay compound between polyamides by in-situ polymerization. Preferably, the layered clay compound is an organized layered clay compound in which an organic material is interposed between the layered clay compounds.

Specifically, the in-situ polymerization is one of the methods of dispersing the organized layered clay compound in a polyamide resin. The polymerization method includes introducing an organized layered clay compound into an ε-caprolactam solution that is a monomer of polyamide, mixing the mixture, polymerizing the resulting mixture to completely peel off a clay layer, and polymerizing the organized layered clay compound between the polyamide monomers.

Through the in-situ polymerization, the organized layered clay compound is dispersed in the polyamide nanocomposite, and the nanocomposite may simultaneously exhibit high flame retardancy, as well as excellent mechanical characteristics, heat resistance, dimensional stability, moisture absorption resistance, and lightweight property.

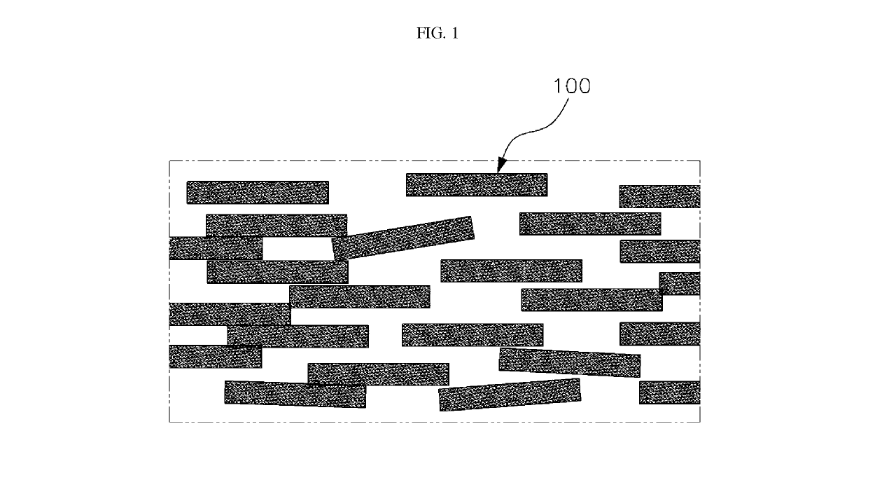

FIG. 1 is a cross-sectional view of one embodiment of the polyamide nanocomposite in which the organized layered clay compound is contained. The organized layered clay compound 100 has a high aspect ratio, and thus hinders the transfer of oxygen between the inside and outside thereof, which makes combustion impossible. This is a reason why the polyamide nanocomposite in which the organized layered clay compound 100 is included has a high flame retardancy. According to an embodiment of the present invention, the material exhibiting flame retardancy may include not only the organized layered clay compound 100, but also one or more further nano clays.

The content of the organized layered clay compound is preferably about 0.1 to 10% by weight, based on the total weight of the flame retardant polyamide resin composition. When the content of the organized layered clay compound is less than about 0.1, it is difficult to provide a flame retardant effect caused by the layered clay compound in the composition. When the content of the organized layered clay compound is more than about 10, an excessive amount of the layered clay compound may hinder the polyamide monomer from being bound together.

Preferably, the polyamide nanocomposite is present in an amount of about 40 to 98% by weight based on the total weight of the polyamide resin composition. When the content of the polyamide nanocomposite is less than about 40% by weight, the flame retardancy of the polyamide resin composition may be sharply reduced. When the content is more than about 98% by weight, the filler and the phosphorus-based flame retardant are added in relatively small amounts, and thus the flame retardancy and physical properties of the polyamide resin composition may be sharply reduced.

The polyamide nanocomposite preferably has a relative viscosity of about 2.5 to 3.5. The relative viscosity, which is a ratio (a/b) of a solution viscosity a to a solvent viscosity b, is one methods of showing the viscosity of a polymer solution, and varies depending on the concentration of the organized layered clay compound. In particular, when the concentration of the organized layered clay compound is high, the relative viscosity is high, and when the concentration of the organized layered clay compound is low, the relative viscosity is low.

Accordingly, when the relative viscosity is less than about 2.5, the organized layered clay compound fails to be present in a sufficient amount in the polyamide resin. This results in a deterioration in the flame retardancy and physical properties of the polyamide nanocomposite. On the contrary, when the relative viscosity is more than about 3.5, the bond between polyamides is hindered from being formed by the organized layered clay compound that is dispersed in an excessive amount. This, results in a deterioration in the physical properties of the polyamide nanocomposite.

### (2) Filler

A filler enables the polyamide nanocomposite to have rigidity, dimensional stability, heat resistance, and lightweight property. It is preferred that the filler includes a fibrous reinforcing material or inorganic filler.

The fibrous reinforcing material preferably includes one or more selected from the group consisting of glass fiber, carbon fiber, natural fiber, mineral fiber, metal fiber, and the like. Most preferably, the fibrous reinforcing material includes a glass fiber. The fibrous reinforcing material preferably has an average diameter of about 10 to 15 μm. When the glass fiber has an average diameter less than about 10 μm, the strength of glass fiber is so weak that it is insufficient to improve the strength of the composition. On the other hand, when the glass fiber has an average diameter more than about 15 μm, the binding force between polyamide nanocomposites may become weak due to the glass fiber having an increased diameter. As a result, the strength of the composition may be decreased.

It is preferred that the inorganic filler includes one or more selected from the group consisting of talc, whisker, calcium carbonate, silica, kaolin, wollastonite, a layered clay compound, and the like.

In addition, the filler is preferably present in an amount of about 1 to 45% by weight based on the total weight of the polyamide resin composition. When the content of the filler is less than about 1% by weight, it is extremely difficult to obtain a satisfactory result in the rigidity, dimensional stability, heat resistance, and flame retardancy of the composition. On the other hand, when the content is more than about 45% by weight, problems such as a deterioration in physical properties, poor surface, poor proccessability, lack of commerciality, and the like may result.

Furthermore, when the content of the filler in the polyamide nanocomposite is about 60 to 80% by weight, it is preferred that the filler and the phosphorus-based flame retardant are present in amounts of about 10 to 25% by weight and about 3 to 5% by weight, respectively, and that the sum thereof is made to be about 13 to 30% by weight.

### (3) Phosphorus-Based Flame Retardant

When most plastic materials, including polyamide resins, are exposed to heat, the plastic materials are easily combusted and during the combustion thereof, toxic gas is emitted. Thus, it is necessary to achieve flame retardancy. Examples of the method of achieving flame retardancy include a method of adding a flame retardant to plastic. Examples of the flame retardants include phosphorus-based flame retardants, halogen-based flame retardants, inorganic-based flame retardants, melanine-based flame retardants, and the like. According to an exemplary embodiment, a phosphorus-based flame retardant is used.

Here, it is preferred that the phosphorus-based flame retardant includes one or more selected from the group consisting of white phosphorus, red phosphorus, ammonium polyphosphate (APP), triphenyl phosphate (TPP), melanine, and the like.

In particular, red phosphorus provides a flame retardant action by hindering the decomposition in the condensed phase and increasing the carbonization rate. The use of red phosphorous is limited due to the red color of the flame retardant itself. While red phosphorus is toxic-free and thermally stable, when it comes into contact with water, phosphine gas is emitted. Thus, care needs to be taken when using red phosphorous.

Preferably, the phosphorus-based flame retardant is present in an amount of about 1 to 30% by weight based on the total weight of the polyamide resin composition. Here, when the content of the phosphorus-based flame retardant is less than about 1% by weight, the flame retardancy of the composition is not high. On the other hand, when the content of the phosphorus-based flame retardant is more than about 30% by weight, a problem of composition ratio with respect to other components occurs, and thus physical properties of the composition may deteriorate.

In addition, it is preferred that the form of the phosphorus-based flame retardant is a white phosphorus powder, a red phosphorus powder, or a master batch. That is, it is preferred that as the phosphorus-based flame retardant, a master batch including a phosphorus-based flame retardant is used. However, it is also possible to directly use a phosphorus-based flame retardant powder.

In particular, according to the present invention, when the contents of the polyamide nanocomposite, the filler, and the phosphorus-based flame retardant are controlled, various physical properties may be obtained. It is also possible to determine and apply the ratio of the composition which satisfies a desired physical property.

Furthermore, it is preferred that the flame retardant polyamide resin composition according to the present invention is applied to vehicles, electric and electronic parts, home appliances, engineering plastics, and the like.

Hereinafter, the present invention will be described in more detail through the following Examples. These Examples are only for illustrating the present invention, and it will be obvious to those skilled in the art that the scope of the present invention is not interpreted to be limited by these Examples.

### EXAMPLE

A composition in which a polyamide nanocomposite, a filler, and a phosphorus-based flame retardant are blended at ratios set forth in the following Table was subjected to injection molding by following the standards of American Society for Testing and Materials (ASTM), thereby preparing specimens.

TABLE 1

| | | | | | | | | Comparative | | |
|---|---|---|---|---|---|---|---|---|---|---|
| | | Example | | | | | | Example | | |
| Composition | Unit | 1 | 2 | 3 | 4 | 5 | 6 | 1 | 2 | 3 |
| Polyamide | % by weight | 82 | 77 | 72 | 71.4 | 70.8 | 70.2 | — | — | — |
| nanocomposite | | | | | | | | | | |
| Polyamide resin | % by weight | 79.60 | 74.75 | 69.90 | 69.33 | 68.76 | 68.19 | 77 | 82 | 65 |
| Layered clay | % by weight | 2.40 | 2.25 | 2.10 | 2.07 | 2.04 | 2.01 | — | — | — |
| compound | | | | | | | | | | |
| Filler | % by weight | 15 | 20 | 25 | 25 | 25 | 25 | 23 | 15 | 30 |
| Phosphorus based | % by weight | 3 | 3 | 3 | 3.6 | 4.2 | 4.8 | — | 3 | 5 |
| flame retardant | | | | | | | | | | |

Table 1 is a table showing the constituent components and contents of the Examples and Comparative Examples. As the constituent components of the Examples, a polyamide resin and a polyamide nanocomposite, in which an organized layered clay compound was contained, were applied. In contrast, as the constituent component of the Comparative Examples, a polyamide resin, in which an organized layered clay compound was not included, was applied. Hereinafter, each of the Examples and Comparative Examples will be specifically explained.

In Example 1, based on the total weight of the composition, 82% by weight of a polyamide nanocomposite into which an organized layered clay compound was introduced by in-situ polymerization and 3% by weight of a phosphorus-based flame retardant were first blended, then the mixture was injected using a main feeder, 15% by weight of glass fiber as a filler was injected thereto using a side feeder, and the resulting mixture was processed in a temperature condition from 250 to 270° C. using a multi-shaft ring extruder to prepare a specimen.

In Example 2, a specimen was prepared by the same process as in Example 1, but 77% by weight of the polyamide nanocomposite, 20% by weight of the filler, and 3% by weight of the phosphorus-based flame retardant based on the total weight of the composition were applied.

In Example 3, a specimen was prepared by the same process as in Example 1, but 72% by weight of the polyamide nanocomposite, 25% by weight of the filler, and 3% by weight of the phosphorus-based flame retardant based on the total weight of the composition were applied.

In Example 4, a specimen was prepared by the same process as in Example 1, but 71.4% by weight of the polyamide nanocomposite, 25% by weight of the filler, and 3.6% by weight of the phosphorus-based flame retardant based on the total weight of the composition were applied.

In Example 5, a specimen was prepared by the same process as in Example 1, but 70.8% by weight of the polyamide nanocomposite, 25% by weight of the filler, and 4.2% by weight of the phosphorus-based flame retardant based on the total weight of the composition were applied.

In Example 6, a specimen was prepared by the same process as in Example 1, but 70.2% by weight of the polyamide nanocomposite, 25% by weight of the filler, and 4.8% by weight of the phosphorus-based flame retardant based on the total weight of the composition were applied.

On the other hand, in Comparative Example 1, based on the total weight of the composition, 77% by weight of a polyamide resin in which the organized layered clay compound was not introduced was injected using a main feeder, 23% by weight of glass fiber as a filler was injected using a side feeder, and the resulting mixture was processed in a temperature condition from 250 to 270° C. using a multi-shaft ring extruder to prepare a specimen.

In Comparative Example 2, based on the total weight of the composition, 82% by weight of a polyamide resin in which the organized layered clay compound was not introduced and 3% by weight of a phosphorus-based flame retardant were first blended, then the mixture was injected using a main feeder, 15% by weight of glass fiber as a filler was injected thereto using a side feeder, and the resulting mixture was processed in a temperature condition from 250 to 270° C. using a multi-shaft ring extruder to prepare a specimen.

In Comparative Example 3, a specimen was prepared by the same process as in Comparative Example 2, but 65% by weight of the polyamide resin, 30% by weight of the filler, and 5% by weight of the phosphorus-based flame retardant based on the total weight of the composition were applied.

Hereinafter, the results of physical properties tests of the specimens prepared in accordance with the Table 1 are shown in the following Table.

TABLE 2

| | | | | | | | | Comparative | | |
|---|---|---|---|---|---|---|---|---|---|---|
| | | Example | | | | | | Example | | |
| Evaluation item | Unit | 1 | 2 | 3 | 4 | 5 | 6 | 1 | 2 | 3 |
| Flexural modulus | kg/cm² | 62300 | 70800 | 79000 | 75500 | 76500 | 77000 | 59000 | 50200 | 71000 |
| Tensile strength | kg/cm² | 1075 | 1182 | 1361 | 1411 | 1428 | 1412 | 1203 | 1143 | 1250 |
| Flexural strength | kg/cm² | 1616 | 1860 | 2169 | 2140 | 2185 | 2167 | — | — | — |
| HDT (18.5 kg) | ° C. | 205 | 210 | 215 | 215 | 215 | 215 | 210 | 197 | 215 |
| Moisture | % | 0.25 | 0.27 | 0.29 | 0.3 | 0.28 | 0.32 | 0.5 | 055 | 0.52 |
| absorptivity | | | | | | | | | | |
| Specific weight | — | 1.24 | 1.28 | 1.33 | 1.34 | 1.35 | 1.35 | 1.3 | 1.24 | 1.39 |
| Shrinkage rate | % | 0.36 | 0.33 | 0.30 | 0.29 | 0.29 | 0.30 | 0.32 | 0.40 | 0.28 |
| Surface state | — | ∘ | ∘ | ∘ | ∘ | ∘ | ∘ | ∘ | ∘ | Δ |
| Flame retardancy | — | V1 | V1 | V1 | V0 | V0 | V0 | HB | V2 | V1 |
| grade | | | | | | | | | | |

Table 2 is a table showing results of physical properties tests performed by using specimens prepared based on the constituent components and contents of Table 1. Hereinafter, each of the Examples and Comparative Examples will be described in detail.

The flexural modulus refers to the ratio of stress and deformation within the elastic limit when applying a flexural load to a polyamide resin composition. The larger the flexural modulus is, the larger the resistance to deformation. Thus, the larger this value is, the larger the rigidity of the composition becomes.

The tensile strength refers to the maximum stress when a material is broken by a tensile load. The larger this value is, the larger the rigidity of the composition becomes.

The flexural strength refers to the maximum stress acting on the external surface, which is under tensile stress at the moment of breaking using maximum force which is capable of bending a material without being permanently distorted or damaged. The larger this value is, the larger the rigidity of the composition becomes.

The HDT refers to the Heat Deflection Temperature (HDT), meaning the highest limit temperature at which deformation occurs by an arbitrary amount. The larger this value is, the larger the heat resistance of the composition becomes.

The moisture absorptivity refers to the ratio denoting an amount of steam absorbed by a material and the amount of moisture with respect to the dry weight, and is generally denoted as a percentage. The smaller this value is, the larger the moisture absorption resistance becomes.

The specific weight refers to the ratio of the mass of any material and the mass of a standard material having the same volume as the material. In the present invention, water was used as the standard material. Accordingly, the smaller this value is, the larger the lightweight property becomes.

The shrinkage ratio refers to the value denoting a value obtained by dividing the difference between the cross-sectional area A of a test specimen and the cross-sectional area B of a fractured surface after fracture by the original cross-sectional area A as percentage in the tensile test. The smaller this value is, the larger the dimensional stability becomes.

As a measure denoting the degree of completion of the surface state molding, the ◯ mark denotes an excellent completeness of molding, and the Δ mark denotes a fair completeness of molding.

The flame retardancy grade refers to the test result of a vertical combustion test (UL 94 V). In terms of flame retardancy, the V0 grade denotes best, the V1 grade denotes fair, and the V2 grade denotes weak.

From the results of physical properties tests in Table 2, it was demonstrated that the flame retardant polyamide resin compositions in Examples 1 to 6, (in which a polyamide nanocomposite in which the layered clay compound was included, according to the present invention, was applied) were better than Comparative Examples 1 to 3 (which did not include the layered clay compound), in terms of rigidity, heat resistance, moisture absorption resistance, lightweight property, and flame retardancy.

More specifically, Examples 1 to 6 have values such as an average flexural modulus of 73517 kg/cm², an average tensile strength of 1312 kg/cm², an average HDT 212.5° C., an average moisture absorptivity of 0.285, an average specific weight of 1.315, an average shrinkage ratio of 0.312, and an average flame retardancy grade of V0.5.

Accordingly, from the results of Examples 1 to 6 which all demonstrated excellent flexural modulus, tensile strength, HDT, moisture absorptivity, and flame retardancy grade compared to Comparative Example 1, it was shown that the present invention has excellent strength, heat resistance, moisture absorption resistance, and flame retardancy, lightweight property, and dimensional stability, when compared to Comparative Example 2, and that the present invention has excellent strength, moisture absorption resistance, lightweight property, and flame retardancy when compared to Comparative Example 3.

Accordingly, it was possible to conclude that the flame retardant polyamide resin composition according to the present invention has improved physical properties and flame retardancy compared to a polyamide resin composition in the related art.

Further, the composition of Example in accordance with the present invention which used in the physical properties test was applied to an actual vehicle, and then was compared to the Comparative Example in terms of physical properties and economic efficiency.

TABLE 3

| | | |
|---|---|---|
| Classification | Example | Comparative Example |

| Mate- | Composi- | 17% by weight of | | 17% by weight of | |
|---|---|---|---|---|---|
| rial | tion | PA66-GF + | | PA66-GF + | |
| | | 21% by weight of | | 21% by weight of | |
| | | MF + | | MF + | |
| | | 3% by weight of | | Addition of a | |
| | | Nano Clay | | flame retardant | |
| | | | | (bromine-based) | |
| | Specific | 1.45 | | 1.54 | |
| | weight | | | | |
| | Flame | V0 | | V0 | |
| | retardancy | | | | |
| | grade | | | | |
| Parts | Weight | 600 | g | 640 | g |
| | Cost | 2,800 | won | 4,800 | won |

Table 3 is a table comparing physical properties and economic efficiency of the Examples in which the organized layered clay compound was introduced with those of Comparative Example in which a bromine-based flame retardant was added without introducing the organized layered clay compound.

The biggest difference in the compositions of the Example and Comparative Example was whether or not the composition included the organized layered clay compound which was the nano clay. Both the Example (in which the nano clay was added to the polyamide resin) and the Comparative Example (in which the bromine-based flame retardant was added to the polyamide resin) obtained excellent flame retardancy grades. However, based on the fact that the Example had a specific weight of 1.45, which is lighter than a specific weight of 1.54 provided by the Comparative Example, the Example according to the present invention has excellent lightweight property in comparison with the Comparative Example. In addition, the Example according to the present invention had lighter weight and lower cost than the Comparative Example.

The present invention has been described in relation to specific embodiments of the present invention, but this is only illustration and the present invention is not limited thereto. Embodiments described may be changed or modified by those skilled in the art to which the present invention pertains without departing from the scope of the present invention, and various alterations and modifications are possible within the technical spirit of the present invention and the equivalent scope of the claims which will be described below.

What is claimed is:

1. A flame retardant polyamide resin composition comprising:
a polyamide nanocomposite in which an organized layered clay compound is contained;
a filler; and
a phosphorus-based flame retardant.

2. The flame retardant polyamide resin composition of claim 1, wherein the organized layered clay compound is present in an amount of about 0.1 to 10% by weight, the polyamide nanocomposite is present in an amount of about 40 to 98% by weight, the filler is present in an amount of about 1 to 45% by weight, and the phosphorus-based flame retardant is present in an amount of about 1 to 30% by weight, based on a total weight of the flame retardant polyamide resin composition.

3. The flame retardant polyamide resin composition of claim 1, wherein the polyamide nanocomposite comprises one or more selected from the group consisting of polyamide 6, polyamide 66, polyamide 11, polyamide 12, polyamide 610, polyamide 612, polyamide 4, and a polyamide copolymer.

4. The flame retardant polyamide resin composition of claim 1, wherein the organized layered clay compound is introduced into the polyamide nanocomposite by in-situ polymerization.

5. The flame retardant polyamide resin composition of claim 1, wherein the polyamide nanocomposite has a relative viscosity of about 2.5 to 3.5.

6. The flame retardant polyamide resin composition of claim 1, wherein the filler is a fibrous reinforcing material or an inorganic filler.

7. The flame retardant polyamide resin composition of claim 6, wherein the fibrous reinforcing material comprises one or more selected from the group consisting of glass fiber, carbon fiber, natural fiber, mineral fiber, and metal fiber, and the inorganic filler comprises one or more selected from the group consisting of talc, whisker, calcium carbonate, silica, kaolin, wallstonate, and a layered clay compound.

8. The flame retardant polyamide resin composition of claim 1, wherein the phosphorus-based flame retardant comprises one or more selected from the group consisting of white phosphorus, red phosphorus, ammonium polyphosphate (APP), triphenyl phosphate (TPP), and melanine.
